(19) United States
(12) Patent Application Publication
(10) Pub. No.: US 2021/0221023 A1
(43) Pub. Date: Jul. 22, 2021

(54) Applications, Methods And Systems For Additive Manufacturing With SiOC Build Materials

(71) Applicant: Melior Innovations, Inc., Houston, TX (US)

(72) Inventors: Paul Lindquist, Houston, TX (US); Wen Liao, Houston, TX (US); Mark Land, Houston, TX (US); Richard Landtiser, Houston, TX (US)

(73) Assignee: Melior Innovations, Inc., Houston, TX (US)

(21) Appl. No.: 17/156,055

(22) Filed: Jan. 22, 2021

Related U.S. Application Data
(60) Provisional application No. 62/964,591, filed on Jan. 22, 2020.

(51) Int. Cl. B28B 1/00; C04B 35/56; C04B 35/65; B33Y 10/00; B22F 10/28

(52) U.S. Cl. CPC B28B 1/001; B33Y 30/00; C04B 35/65; B33Y 10/00; B22F 10/28; C04B 2235/3895; C04B 2235/483; C04B 2235/404; C04B 2235/402; C04B 2235/407; C04B 2235/405; C04B 2235/408; C04B 2235/6026; C04B 2235/665; C04B 35/5603

(57) ABSTRACT

Optical additive manufacturing, including laser additive manufacturing systems, apparatus and methods using polymer derived ceramic build materials. Additive manufacturing build materials are made of polymer derived ceramic including SiOC, precures, cured materials, hard cured materials, and pyrolized materials. Polymer derived ceramic build materials are mixed with and used in conjunction with other build materials.

### BACKGROUND OF THE INVENTION

### Field of the Invention

The present inventions relate to optical, including laser, systems, apparatus and methods for manufacturing using polymer derived ceramic build materials. The present inventions further relate to laser manufacturing processes, systems and devices, and in particular to laser additive manufacturing processes, and laser additive-subtractive manufacturing processes using build materials having polymer derived ceramic SiOC.

Generally, optical additive manufacturing, e.g., three-dimension or 3-D printing, uses a build material that was either reached, melted, fused, or otherwise processed, when exposed to light, either non-coherent light or coherent light. The build materials could be liquids, powder, gels and combinations and variations of these. Generally, the build materials were plastics and metals. The build materials would be exposed to the light in a predetermined pattern (e.g., template, scanned laser beam, mask, etc.) to “build” in a step-by-step manner the final article, i.e., the built article. This article could then, in some situations, require or otherwise, be further processes, such as grinding, polishing, or cutting. The steps of building and removing could be repeated one or more time.

It is believed that prior to the present inventions, polymer derived ceramic starting materials had never been used in laser 3-D printing applications. In particular it is believed that liquid, cured, and ceramic SiOC polymer derived ceramic materials, and combinations and variations of these, prior to the present inventions, had never been used in laser additive manufacturing.

As used herein, unless expressly provided otherwise, the terms “build material”, “starting material” and similar such terms should be given their broadest possible meaning and would include the materials that are used at the start of the additive manufacturing process, and from which the predetermined article is made, and would include fibers, ribbons, powders, powder beds, 3-D printing ink, liquids, binders and combinations and variations of these, as well as, any other material that is placed in a 3-D printing system for the purpose of subjecting that material to a predetermined laser beam pattern for the purpose of building a predetermined article.

As used herein, unless expressly provided otherwise, the terms “existing build material”, existing starting materials”, “prior build material”, “prior starting material” and similar such terms refer to additive manufacturing starting materials that were known prior to the present inventions.

As used herein, unless expressly provided otherwise, the terms “other starting materials”, “other building materials”, refers to all existing build materials and includes Magnesium, Aluminum, Gallium, Tin, Lead, Titanium, Vanadium, Chromium, Manganese, Iron, Cobalt, Nickel, Copper, Zinc, Zirconium, Molybdenum, Rhodium, Palladium, Silver, Cadmium, Tungsten, Gold, and Mercury, alloys of these and other metals, Inconel 625, Invar, Stainless Steel, Stainless Steel 304 and mixtures and variations of these and other metals and alloys, Silicon Carbide, photo-structurable, aluminosilicate glass-ceramic substrates; Aluminum filled plastics; impact resistant Nylon; Nylon; ABS, PLA, glass filled Nylon; Flame retardant Nylon; Carbon fiber; Carbon fiber filled Nylon; and epoxy resins, to name a few.

As used herein, unless expressly provided otherwise, the terms “additive manufacturing” (“AM”) unless expressly provided otherwise, should be given its broadest possible meaning and would include processes and systems such as optical additive manufacturing (OAM), laser additive manufacturing (LAM), Fused deposition modeling (FDM), Stereolithography (SLA), Digital Light Processing (DLP), Selective Laser Sintering (SLS), Selective laser melting (SLM), Laminated object manufacturing (LOM) and Digital Beam Melting (EBM).

As used herein, unless expressly provided otherwise, the terms “optical additive manufacturing” (“OAM”), should be given its broadest possible meaning and would include processes, application and systems where light (coherent, non-coherent and both) is delivered in a predetermined manner (e.g., template, scanned laser beam, mask, etc.) to a build material, to form the build material into a predetermined article, and would include laser additive manufacturing and stereolithography. It should be noted that optical additive manufacturing systems, apparatus and methods may also employ devices and methods, such as preheaters, annealers, and coolers.

As used herein, unless expressly provided otherwise, the terms “laser additive manufacturing” (“LAM”), “laser additive manufacturing processes”, “additive manufacturing systems” and similar such terms are to be given their broadest possible meanings and would include such processes, applications and systems as 3-D printing, three dimensional printing, sintering, welding, and brazing, as well as any other process that utilizes a laser beam at least during one stage of the making of an article (e.g., product, component, and part) being made. These terms are not limited to or restricted by the size of the article being made, for example they would encompass articles that are from submicron, e.g., less than 1 μm, to 1 μm, to 10 μm, to tens of microns, to hundreds of microns, to thousands of microns, to millimeters, to meters to kilometers (e.g., a continuous LAM process making a ribbon or band of material).

As used herein, unless expressly provided otherwise, the term “additive-subtractive manufacturing” is to be given its broadest possible meaning and would include all processes, applications and systems such as LAM and optical additive manufacturing, where one or more additional steps of removing material from the build article is preformed, such as for example machining, polishing, grinding, cutting and drilling. An additive-subtractive manufacturing process can repeat the steps of building the build material into an article, removing material and building additional material onto, or into, the article any number of times.

As used herein, unless expressly provided otherwise, the terms “laser beam spot size” and “spot size” are to be given their broadest possible meaning and include: the transverse cross-sectional shape of the laser beam; the transverse cross sectional area of the laser beam; the shape of the area of illumination of the laser beam on a target; the area of illumination of a laser beam on a target

As used herein, unless expressly provided otherwise, the terms “functional additive manufacturing laser beam”, “functional beam”, “functional laser beam” and similar such terms, mean laser beams having the power, wavelength, fluence, irradiance (power per unit area) and combinations and variations of these properties to form or build the starting or target materials into an article; by having the laser beam effect these materials, e.g., sinter, braze, anneal, weld, melt, join, tackify, soften, cross-link, bond, react, etc.

As used herein, unless expressly stated otherwise, “UV”, “ultra violet”, “UV spectrum”, and “UV portion of the spectrum” and similar terms, should be given their broadest meaning, and would include light in the wavelengths of from about 10 nm to about 400 nm, and from 10 nm to 400 nm.

As used herein, unless expressly stated otherwise, the terms “visible”, “visible spectrum”, and “visible portion of the spectrum” and similar terms, should be given their broadest meaning, and would include light in the wavelengths of from about 380 nm to about 750 nm, and 400 nm to 700 nm.

As used herein, unless expressly stated otherwise, the terms “blue laser beams”, “blue lasers” and “blue” should be given their broadest meaning, and in general refer to systems that provide laser beams, laser beams, laser sources, e.g., lasers and diodes lasers, that provide, e.g., propagate, a laser beam, or light having a wavelength from 400 nm (nanometer) to 500 nm, and about 400 nm to about 500 nm.

As used herein, unless expressly stated otherwise, the terms “green laser beams”, “green lasers” and “green” should be given their broadest meaning, and in general refer to systems that provide laser beams, laser beams, laser sources, e.g., lasers and diodes lasers, that provide, e.g., propagate, a laser beam, or light having a wavelength from 500 nm to 575 nm, about 500 nm to about 575 nm.

Generally, the term “about” and the symbol “˜” as used herein, unless specified otherwise, is meant to encompass a variance or range of ±10%, the experimental or instrument error associated with obtaining the stated value, and preferably the larger of these.

As used herein, unless stated otherwise, room temperature is 25° C. And, standard ambient temperature and pressure is 25° C. and 1 atmosphere. Unless expressly stated otherwise all tests, test results, physical properties, and values that are temperature dependent, pressure dependent, or both, are provided at standard ambient temperature and pressure, this would include viscosities.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

The term “nanocomposite” as used herein and unless specifically stated otherwise, is intended to have its broadest possible meaning. The term is not intended to limit, or even relate to the size of a volumetric shape that the nanocomposite material may be formed into, e.g., a macro-structure. For example, the nanocomposite material may be used to form macro-structures, e.g., building components such as an I-beam, a large truck cluck, the wing of an airplane, a proppant for hydraulic fracturing, a pigment, spherical like beads having diameters from about 8,000 μm to about 0.1 μm, and particles having cross sections from about 8,000 μm to about 0.1 μm. Smaller and larger sizes and various shapes and configurations of macro-structures are contemplated. (See, e.g., the shapes, structures and applications disclosed and taught in US Patent Application Publ. Nos. 2015/0175750, 2014/0326453, 2016/0046529, 2016/0207782, and 2015/0252166, the entire disclosures of each of which are incorporated herein by reference.) Rather, the term, “nano-” as used in the term nanocomposite, relates to the micro-structure of these materials.

In general, the term “nanocomposite,” as used herein, and unless specifically provided otherwise, conveys that in embodiments of this material there are one, two, three, four or more different components; and one or more of these components can be in one, two, three, four or more different states (e.g., association of an atom with other atoms, nature of atomic bonds (e.g., covalent, ionic, sp², sp³, etc.), structure (e.g., crystalline, amorphous, planer, tubes, spheres, grains, cubes, etc.)).

As used herein, unless specified otherwise the terms %, weight % and mass % are used interchangeably and refer to the weight of a first component as a percentage of the weight of the total, e.g., formulation, mixture, preform, material, structure or product. The usage X/Y or XY indicates weight % of X and the weight % of Y in the formulation, unless expressly provided otherwise. The usage X/Y/Z or XYZ indicates the weight % of X, weight % of Y and weight % of Z in the formulation, unless expressly provided otherwise. (As used herein unless specifically stated otherwise, “50/50”, “5050” and “50:50” refer to formulations having 50% MHF and 50% DCPD.)

As used herein, unless specified otherwise “volume %” and “% volume” and similar such terms refer to the volume of a first component as a percentage of the volume of the total, e.g., formulation, mixture, preform, material, structure or product.

An example of systems and methods employed today in optical additive manufacturing is the use of an infrared laser and a galvanometer to scan the laser beam across the surface of a powder bed in a predetermined pattern. The IR laser beam is of sufficient intensity to create a welding process that melts and fuses the liquified powder to the lower layer or substrate.

Another example of systems and methods employed today in optical additive manufacturing is the use of a binder being sprayed into a powder bed followed by a consolidation step at high temperatures, or a high-power single mode laser beam scanned over the powder bed by a galvanometer system at high speeds.

Another example of systems and methods for optical additive manufacturing is the use of one or more laser beams focused into a liquid build material to form a predetermined article.

This Background of the Invention section is intended to introduce various aspects of the art, which may be associated with embodiments of the present inventions. Thus the forgoing discussion in this section provides a framework for better understanding the present inventions, and is not to be viewed as an admission of prior art.

### SUMMARY

There has been a long-standing and unfulfilled need for, among other things, better build materials for use in optical additive manufacturing processes, and in particular laser 3-D printing applications. The present inventions, among other things, solve these needs by providing the improvements, articles of manufacture, devices and processes taught, and disclosed herein.

### BRIEF DESCRIPTION OF THE DRAWINGS

FIG. 1 is a schematic perspective view of an embodiment of a LAM system and process a polymer derived ceramic build material in accordance with the present inventions.

FIG. 2 is a perspective view of a LAM system having a polymer derived ceramic build material in accordance with the present inventions.

FIG. 3 is a perspective view of a LAM system having a polymer derived ceramic build material in accordance with the present inventions.

### DESCRIPTION OF THE PREFERRED EMBODIMENTS

In general, the present inventions relate to optical additive manufacturing using build materials that are based upon polymer derived preceramic and ceramic materials; and in particular, polysilocarb compositions, structures and materials.

In general, the present inventions relate to build materials for optical additive manufacturing, including LAM, and the resulting built article, that are unique silicon (Si) based materials that are easy to manufacture, handle and have surprising and unexpected properties and applications. These silicon based build materials have applications and utilizations as a liquid material, a cured material, e.g., a plastic, a preceramic, and a pyrolized material, e.g., a ceramic. These silicon based built articles have application and utilizations as a cured material, e.g., a plastic, a preceramic, and a pyrolized material, e.g., a ceramic.

Thus, the present inventions provide: new build or starting materials, including OAM build materials and LAM build materials; additive manufacturing systems and processes, including OAM systems and processes and LAM systems and processes; and built articles for these starting materials.

In embodiments there are provided a system and method for 3-D printing nanocomposite materials.

In embodiment there are provided systems and methods for 3-D printing a nanocomposite material having silicon, carbon oxygen and free carbon.

In embodiments there are provided nanocomposite 3-D printed articles comprising silicon carbon and oxygen.

In embodiments there are provided an optical additive manufacturing built article, and systems and methods making such built articles, wherein the article has one or more of the following moieties: Si(CH₃)₃O, SiC₄, Si(CH₃)₂O₂, SiC₂O₂, Si(CH₃)(OH)O₂, SiCO₃, SiO₄, esters, ketones, conjugated aliphatic carbon structures, aromatic sp² carbon structures, —C—O—C—, —C—O—Si—, alkanes, terminal end Si(CH3)2O, —Si—C—C—Si—Si(CH3)O2, and sp² carbon structures of 6 to 20 carbons,

In embodiments there are provided an optical additive manufacturing built article, and systems and methods making such built articles, wherein the article has one or more of the following features: a specific gravity of from about 1.8 to about 2.2 and being substantial free of nano-voids larger than 0.01 μm; a specific gravity of from about 1.8 to about 2.2 and being substantial free of nano-voids larger than 0.1 μm; having a specific gravity of from about 1.8 to about 2.5 and being substantial free of nano-voids larger than 0.001 μm; a specific gravity of from about 1.8 to about 2.2 and being substantial free of nano-voids larger than 0.01 μm; a specific gravity of from about 1.8 to about 2.5 and being substantial free of nano-voids larger than 0.01 μm; and, having a specific gravity of from about 1.8 to about 2.2 and being substantial free of nano-voids larger than 0.001 μm.

In embodiments there are provided an optical additive manufacturing built article, and systems and methods making such built articles, wherein the article has one or more of the following features: a specific gravity of from about 1.8 to about 17 and being substantial free of nano-voids larger than 0.01 μm; a specific gravity of from about 2.5 to about 8 and being substantial free of nano-voids larger than 0.1 μm; having a specific gravity of from about 2.0 to about 10 and being substantial free of nano-voids larger than 0.001 μm; a specific gravity of from about 3 to about 12 and being substantial free of nano-voids larger than 0.01 μm; a specific gravity of from about 2.2 to about 15 and being substantial free of nano-voids larger than 0.01 μm; and, having a specific gravity of from about 2.2 to about 5 and being substantial free of nano-voids larger than 0.001 μm.

In embodiments there are provided an optical additive manufacturing built article, and systems and methods making such built articles, wherein the article has one or more of the following features; a density of from about 1.8 g/cc to about 2.2 g/cc and being substantial free of nano-voids larger than 0.1 μm; having a density of from about 1.8 g/cc to about 2.5 g/cc and being substantial free of nano-voids larger than 0.001 μm; a density of from about 1.8 g/cc to about 2.2 g/cc and being substantial free of nano-voids larger than 0.01 μm; a density of from about 1.8 g/cc to about 2.5 g/cc and being substantial free of nano-voids larger than 0.01 μm; and, having a density of from about 1.8 g/cc to about 2.2 g/cc and being substantial free of nano-voids larger than 0.001 μm.

In embodiments there are provided an optical additive manufacturing built article, and systems and methods making such built articles, wherein the article has one or more of the following features: a density of from about 1.8 g/cc to about 17 g/cc and being substantial free of nano-voids larger than 0.01 μm; a density of from about 2.5 g/cc to about 8 g/cc and being substantial free of nano-voids larger than 0.1 μm; having a density of from about 2.0 g/cc to about 10 g/cc and being substantial free of nano-voids larger than 0.001 μm; a density of from about 3 g/cc to about 12 g/cc and being substantial free of nano-voids larger than 0.01 μm; a density of from about 2.2 g/cc to about 15 g/cc and being substantial free of nano-voids larger than 0.01 μm; and, having a density of from about 2.2 g/cc to about 5 g/cc and being substantial free of nano-voids larger than 0.001 μm.

In embodiments there are provided an optical additive manufacturing built article, and systems and methods making such built articles, wherein the article has one or more of the following features: a first composition having a free carbon domain and a second composition having a plurality of silicon based moieties; and wherein the first and second compositions are different compositions.

In embodiments there are provided an optical additive manufacturing built article, and systems and methods making such built articles having one or more of the following features: wherein the free carbon domain is selected from the group consisting of sp² carbon, aromatic structures having 6 or more carbons, bent ring aromatic structures, conjugated aliphatic carbons, conjugated aliphatic carbons having from 3 to 10 carbons, conjugated aliphatic carbons having from 10 to 20 carbons, and alkanes; wherein the free carbon domain is selected from the group consisting of turbostratic, amorphous, graphenic, and graphitic; wherein at least one of the moieties is selected from the group consisting of Si(CH₃)₃O, SiC₃O, SiC₄, Si(CH₃)₂O₂, SiC₂O₂, Si(CH₃)(OH)O₂, SiCO₃ SiO₄, esters, ketones, C—O—C, C—O—Si, Si(CH₃)₂O, Si—C—C—Si, Si(CH₃)₂O₂, and Si(CH₃)O₂; wherein at least one of the moieties is selected from the group consisting of Si(CH₃)₃O, SiC₃O, SiC₄, Si(CH₃)₂O₂, SiC₂O₂, Si(CH₃) (OH)O₂, SiCO₃ SiO₄, esters, ketones, C—O—C, C—O—Si, Si(CH₃)₂O, Si—C—C—Si, Si(CH₃)₂O₂, and Si(CH₃)O₂; wherein at least one of the moieties is selected from the group consisting of Si(CH₃)₃O, SiC₃O, SiC₄, Si(CH₃)₂O₂, SiC₂O₂, Si(CH₃) (OH)O₂, SiCO₃ SiO₄, esters, ketones, C—O—C, C—O—Si, Si(CH₃)₂O, Si—C—C—Si, Si(CH₃)₂O₂, and Si(CH₃)O₂; having a specific gravity of from about 1.5 g/cc to about 1.9 g/cc and having nano-voids larger than 0.001 μm; having a specific gravity of from about 1.1 g/cc to about 1.5 g/cc and having nano-voids larger than 0.01 μm; having a specific gravity of from about 1.6 g/cc to about 2.5 g/cc and being substantial free of nano-voids larger than 0.01 μm; having a specific gravity of from about 1.6 g/cc to about 2.5 g/cc and being substantial free of nano-voids larger than 0.001 μm; having a specific gravity of from about 1.6 g/cc to about 2.5 g/cc and being substantial free of nano-voids larger than 0.0001 μm.

In embodiments there is provided an optical additive manufacturing built article, and systems and methods making such built articles that have one or more of the following features: wherein the free carbon domain has a cross section of from about 2 to about 3.4 μm; wherein the free carbon domain has a cross section of from about 2 to about 5.5 μm; wherein the free carbon domain has a cross section of from about 3.5 to about 4.9 μ; and, wherein the free carbon domain has a cross section of from about 3.8 to about 5.2 μm.

In embodiments of the built article for the OAM process can build an article that has nanocomposites in the article, and these nanocomposites can have one or more of the forgoing components having a cross section of less than about 1 μm, less than about 0.1 μm, less than about 0.01 μm, and less than about 0.001 μm; and from about 0.001 μm to about 1 μm, from about 0.002 μm to about 0.005 μm, from about 0.001 μm to about 0.01 μm, and from about 0.01 μm to about 0.1 μm. Larger and smaller sizes are contemplated.

In embodiments of the nanocomposites one or more of the foregoing components having a cross section of greater than about 0.1 μm, greater than about 1 μm, greater than about 10 μm, and greater than about 100 μm; and from about 0.01 μm to about 150 μm, from about 0.001 μm to about 100 μm, from about 0.1 μm to about 0.10 μm, and from about 1 μm to about 20 μm. Larger and smaller sizes are contemplated.

In embodiments of the 3-D printed nanocomposites, one or more of the components can constitute the bulk, or matrix phase, (e.g., a continuous, or substantially continuous phase) of the nanocomposite, and one or more of the components can constitute the dispersed or non-continuous phase. It being understood that in some embodiments the bulk phase and the non-continuous phase may be intertwined, or otherwise associated, to such an extent that they can be viewed as two or more continuous phases with no non-continuous phase; or two of more non-continuous phases with no continuous phase; and combinations and variations of these and other features. Thus, embodiments where multiple and different components, and components in multiple and different states, represent the bulk phase of the nanocomposite, the dispersed phase of the nanocomposite and combinations and variations of these and other features, are contemplated.

In embodiments of the present inventions the components of the starting materials, the final printed article and both, can be carbon (C), nitrogen (N), silicon (Si), oxygen (O), boron (B), as well as, other elements and compounds. Such as, for example, Aluminum, Titanium, Zirconium, Hafnium, Vanadium, Niobium, Tantalum, Yttrium, Lanthanum, Cerium, Praseodymium, Neodymium, Samarium, Europium, Gadolinium, Terbium, Dysprosium, Holmium, Erbium, Thulium, Ytterbium, Lutetium, rare earths, Phosphorous, Magnesium, Sodium, Calcium, Iron, Cobalt, Zinc, Copper, Beryllium, Nickel, Molybdenum, and metal matric composites (macroscopic and microscopic).

Embodiments of the starting materials, and the built article include polymer derived ceramic (“PDC”) materials, products and applications that are using, based on, or constituting PDCs generally.

Polymer derived ceramics (PDC) are ceramic materials that are derived from, e.g., obtained by, the pyrolysis of polymeric materials. Polymer derived ceramics may be derived from many different kinds of precursor formulations, e.g., starting formulations. PDCs may be made of, or derived from, carbosilane or polycarbosilane (Si—C), silane or polysilane (Si—Si), silazane or polysilazane (Si—N—Si), silicon carbide (SiC), carbosilazane or polycarbosilazane (Si—N—Si—C—Si), siloxane or polysiloxanes (Si—O), to name a few.

Embodiments of the present build materials preferably use, are based upon or constitute PDCs that are “polysilocarb” materials, e.g., materials containing silicon (Si), oxygen (O) and carbon (C), and embodiments of such materials that have been cured, and embodiments of such materials that have been pyrolized. Polysilocarb materials may also contain other elements. Polysilocarb materials are made from one or more polysilocarb precursor formulation or precursor formulation. The polysilocarb precursor formulation contains one or more functionalized silicon polymers, or monomers, non-silicon based cross linkers, as well as, potentially other ingredients, such as for example, inhibitors, catalysts, fillers, dopants, modifiers, initiators, reinforcers, fibers, particles, colorants, pigments, dies, the same or other PDCs, ceramics, metals, metal complexes, and combinations and variations of these and other materials and additives. Silicon oxycarbide materials, SiOC compositions, and similar such terms, unless specifically stated otherwise, refer to polysilocarb materials, and would include liquid materials, solid uncured materials, cured materials, ceramic materials, and combinations and variations of these.

Examples of PDCs, PDC formulations, potential precursors, and apparatus and methods for making these materials, that can be used, or adapted and improved upon employing the teachings of this specification to be used, in embodiments of the present inventions are found, for example, in US Patent Publication Nos. 2014/0274658, 2014/0323364, 2015/0175750, 2016/0207782, 2016/0280607, 2017/0050337, 2008/0095942, 2008/0093185, 2007/0292690, 2006/0069176, 2006/0004169, and 2005/0276961, and U.S. Pat. Nos. 9,499,677, 9,481,781, 8,742,008, 8,119,057, 7,714,092, 7,087,656, 5,153,295, and 4,657,991, and the entire disclosures of each of which are incorporated herein by reference.

Generally, the liquid polysilocarb precursor formulation is cured to form a solid or semi-sold material, e.g., cured material, green material, or plastic material. This material may be further cured, under predetermined conditions. The material may also be pyrolized under predetermined conditions to form a ceramic material. These processing conditions, and the particular formulations, can typically, contribute to the performance, features and properties of the end product or material. Typically, inhibitors and catalysis, as well as, or in addition to the selection of curing conditions, may be used to determine, contribute to, or otherwise affect, processing conditions, as well as, end properties of the material.

Generally, in an embodiment of an OAM system and process a PDC build material is placed into a building area in the OAM system. A predetermined finished article shape, a program to deliver the optical energy, i.e., the light, to the build material in the build area, and combinations and variations of these, are contained in the OAM system. This system then delivers the predetermined light pattern to the build material to build the article. Additional build material can then be added to the built article and the light delivered in a predetermined pattern to continue building the article. This process can be completed until the article is built. In a preferred embodiment the build material is a polymer derived ceramic, and in a more preferred embodiment the build material is a polysilocarb.

Generally, in an embodiment a cured PDC, and preferably a cured polysilocarb material is coating with a liquid PDC, and preferably a polysilocarb liquid, and then the predetermined light in the OAM process is applied to cure the liquid PDC and build the article. In this manner the liquid PDC build material functions as a binder. In an embodiment the build material can be a non-PDC material (e.g., a metal powder, a plastic such as nylon, or other plastic typically used as a 3-D printer build material) and the binder can be the liquid PDC material.

In an embodiment the PDC build material, preferably the polysilocarb build material, is pyrolized into a ceramic to provide a ceramic article.

In an embodiment, cured PDC materials, pyrolized PDC materials, and both are added to other types of existing build materials, such as: metals (e.g., gold, cooper, aluminum, steel, stainless steal, etc.); thermoplastics (e.g., ABS (acyrylonitrile butadiene styrene), PLA (polyactic acid or polylactide), etc.); nylon; and epoxy resins to name a few.

In an embodiment, a liquid PDC materials is used as a binder, being sprayed, coated or otherwise applied to a build material, such as a cured PDC build material (e.g., SiOC material), a pyrolized PDC build material (e.g., SiOC material), metals (e.g., gold, cooper, aluminum, steel, stainless steal, etc.), a thermoplastics (e.g., ABS (acyrylonitrile butadiene styrene), PLA (polyactic acid or polylactide), etc.), a nylon; an epoxy resin, and other build materials, to name a few.

In embodiments the PDC building material is selected to enhance the efficiency of the laser energy being absorbed into the build material. Thus, from about 0.5% to about 75%, about 1% to about 50%, about 10% to about 50%, about 5% to about 40% of a PDC build material can be added to the other build material. Preferably, in this embodiment the PDC build material (e.g., SiOC material) has greater absorptivity for the wavelength of the laser beam than the other build material, has lower reflectivity for the wavelength of the laser beam than the other build material, and both. These increased efficiencies can provide benefits, among others, such as high build speed and greater resolution in the build article.

In embodiments, the PDC build material is a ceramic, such as an SiOC ceramic material, and the other build material is a metal, such as aluminum or titanium, and the built article is a cermet.

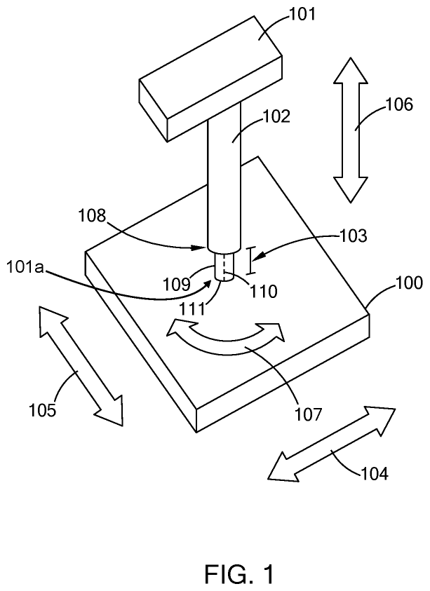

Turning to FIG. 1 there is shown a schematic diagram illustrating an embodiment of a LAM system and process. Thus, there is a base 100, a laser unit 101, a laser beam delivery assembly 102. The laser beam delivery assembly 102 has a distal end 108 that is at a stand off distance 103 from the base 100 (and at a stand of distance from the starting material, when starting material is present on the base). Typically during a LAM process starting material 100a is supported by the base 100.

The starting material can be a PDC, an SiOC ceramic, a hard cured SiOC, a cured SiOC, a mixture of PDC, (e.g., SiOC ceramic, hard cured, or cured materials) and an existing starting material. The starting material can have a liquid PDC applied to it, in the system, or prior to being placed on the base 100. This liquid PDC build material, in embodiments can: function as a binder (before the building of the article, after the building of the article and both); enhance the building of the article; enhance the strength of the article; enhance the resolution of the article; and combinations of these, and other improvements, compared to a systems and articles without the use of the liquid PDC.

The starting material and the laser beam are then moved relative to each other as the functional laser beam 109 travels along beam path 110, to form a laser spot 111 that contacts the starting material 101a, and joins the starting material together to form an article. The relative motion (e.g., raster scan) of the starting material and the laser spot is illustrated by arrows 104 (e.g., x-axis motion), 105 (e.g., y-axis motion), 106 (e.g., z-axis motion), and 107 (e.g. rotation), additionally the angle at which the laser beam path and the laser beam strikes the base, and thus the starting material on the base, can be changed. The laser spot may also be moved in a vector fashion, where both x and y motion occur simultaneously moving the spot to a predetermined position on the material. The angle of the laser beam on the target in FIG. 1 is at 90° or a right angle to the base. This angle can be varied from 45° to 135°, from 30° to 120°, and from 0° to 180°, and from 180° to 360° (e.g. the article is inverted to make, for example, a U shaped lip.) Further combinations and variations of these different basic relative motions can be performed, in coordination with the firing of the laser beam and deposition of starting material, and in this manner articles of many different shapes, sizes and with varying degrees of complexity can be made. It being understood that these relative motions can be achieved by moving the base, moving the laser delivery assembly, steering the laser beam (e.g., scanning the beam with galvo-scanners) and combinations and variations of these.

The laser unit and the laser beam delivery assembly can be one integral apparatus, or they can be separated and optically connected, for example via optical fibers or a flying optic head. Further, some or all of the components of the laser unit can be in the laser beam delivery assembly, and vice versa. Also, these components, and other components, can be located away from the laser unit and the laser beam delivery assembly. These remote components can be optically associated, functionally associated (e.g., control communication, data communication, WiFi, etc.) and both, with the laser unit and the laser beam delivery assembly. The laser unit and the laser beam delivery assembly generally have a high power laser in the visible, IR, UV spectrums. The color of the PDC starting material may be varied to enhance the absorption of the laser beam.

Preferably, the laser unit has a high power laser that is capable of generating, and propagating, a laser beam in a predetermined wavelength and delivers the laser beam to the laser beam delivery assembly, which can shape and deliver the laser beam from the distal end along the laser beam path to the target, e.g., the starting material, which could be on the base or on an article being built.

A delivery device for providing the starting material may also be in, adjacent to, or otherwise operably associated with the laser beam delivery apparatus, or otherwise associated with it. In this manner the starting material can be delivered, e.g., sprayed, flowed, conveyed, drawn, poured, dusted, on to the base or on to the article being made. Thus, for example the starting material can be delivered through a jet, a nozzle, a co-axial jet around the laser beam, an air knife or doctor blade assembly, any apparatus to deliver the starting material ahead of the movement of the laser beam, spray nozzles, and other devices for delivering and handling the starting material. For example, starting material delivery devices, and processes for delivering starting materials, that are found in 3-D printing applications can be used.

Embodiments of 3-D printing apparatus systems and methods are disclosed and taught in U.S. Pat. Nos. 5,352,405, 5,340,656, 5,204,055, 4,863,538, 5,902,441, 5,053,090, 5,597,589, and US Patent Application Publication No. 2012/0072001, the entire disclosure of each of which is incorporated herein by reference. In a preferred embodiment of the present inventions, these apparatus, systems and methods use SiOC polymer derived ceramic, liquids, cured materials, pyrolized materials and combinations and variations of these as starting materials. This SiOC starting materials may be used alone, i.e., the staring material is entirely made up of SiOC, or in conjunction with other materials and other starting materials.

A control system preferably integrates, monitors and controls the operation of the laser, the movement of various components to provide for the relative movement to build the article, and the delivery of the starting material. The control system may also integrate, monitor and control other aspects of the operation, such as monitoring, safety interlocks, laser operating conditions, and LAM processing programs or plans. The control system can be in communication with, (e.g., via a network) or have as part of its system, data storage and processing devices for storing and calculating various information and data relating to items, such as, customer information, billing information, inventory, operation history, maintenance, and LAM processing programs or plans, to name a few.

A LAM processing program or plan is a file, program or series of instructions that the controller implements to operate the LAM device, e.g., a 3-D printer, to perform a predetermined LAM process to make a predetermined article. The LAM processing plan can be, can be based upon, or derived from, a 3-D drawing or model file, e.g., CAD files, such as files in standard formats including, for example, .STEP, .STL, .WRL (VRML), .PLY, .₃DS, and .ZPR. The controller has the LAM processing plan (e.g., in its memory, on a drive, on a storage device, or available via network) and uses that plan to operate the device to perform the LAM process to build the intended article. The controller may have the capability to directly use the 3-D model file, or convert that file to a LAM processing plan. The conversion may be done by another computer, and made directly available to the controller, or held in memory, or on a storage device, for later use. An example of a program to convert a 3-D model file to a LAM processing plan is ZPrint™ from Z Corp.

It should be understood that a built article, or made article, can be, for example, a finished end product, a finished component for use in an end product, a product or component that needs further processing or additional manufacturing steps, a material for use in other applications, and a coating on a substrate, for example a coating on a wire.

The particle size and shape can be predetermined with respect to a predetermined functional laser beam spot. Thus, for example the particles can have a size that is smaller than the laser beam spot (e.g., ½, ⅕, 1/10), that is about the same as the laser beam spot, 2× larger than the spot, 3× larger than the spot, 5× larger than the spot, and 10× larger than the spot. The particles can have shapes that are essentially the same as the shape of the laser beam spot, e.g., spherical beads for a circular spot, or that are different, and combinations and variations of these.

For a batch of particles in a starting material that has a particle size distribution, when referring to the size of the particles the median particle size distribution, e.g., D₅₀, can be used. Typical 3-D printing machines have an average particle size of 40 □m with the particles ranging in size from 15 □m to 80 □m. Particle distributions that are more tightly controlled are preferred and will improve the surface roughness of the final printed part.

The shape of the particles in the starting material can be any volumetric shape and can include for example, the following: spheres, pellets, rings, lenses, disks, panels, cones, frustoconical shapes, squares, rectangles, cubes, channels, hollow sealed chambers, hollow spheres, blocks, sheets, coatings, films, skins, slabs, fibers, staple fibers, tubes, cups, irregular or amorphous shapes, ellipsoids, spheroids, eggs, multifaceted structures, and polyhedrons (e.g., octahedron, dodecahedron, icosidodecahedron, rhombic triacontahedron, and prism) and combinations and various of these and other more complex shapes, both engineering and architectural. The preferred particles shape is essentially nearly perfect spheres, with a narrow size distribution, to assist in the flowing of the particles through the system as well as reducing the surface roughness of the final part produced. Any shape that reduces the stiction, friction and both, between particles is preferred when the average particle size is smaller than 40 □m.

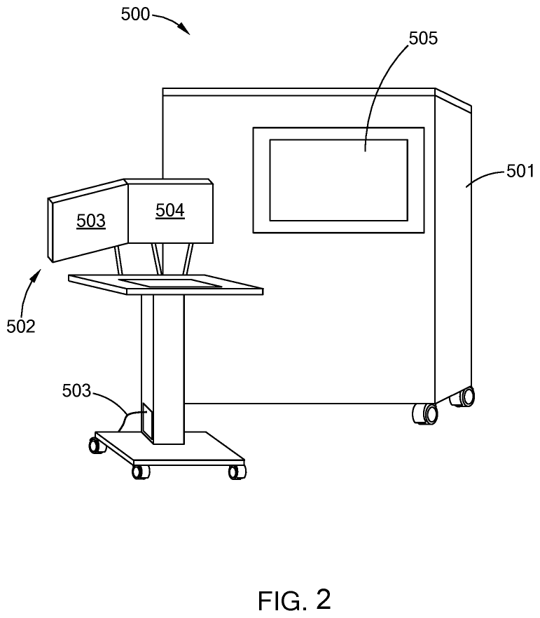

Turning to FIG. 2 there is shown a perspective view of an embodiment of a LAM system 500. The system 500 has a cabinet 501 that contains the laser unit, the laser beam delivery assembly and the base. The cabinet 501 also contains the motors, sensors, actuators, nozzles, starting material delivery devices, and other devices used to perform the relative motion and to deliver the starting material in a predetermined manner, e.g., the equipment and devices to implement the LAM processing plan. The cabinet 501, and more specifically the components within the cabinet 501, are in data and control communication with an operation station 502, having a controller, via cable 503. The controller can be a PLC (programmable logic controller), an automation and device controller, a PC, or other type of computer that can implement the LAM processing plan. In this embodiment the operation station has two GUI (graphic user interfaces) 503, 504, e.g., monitors. The cabinet 501 has an access panel 505, which may be a window having laser safe glass.

The LAM system of FIG. 2 is used to build articles from SiOC build materials, including liquid SiOC materials, cured SiOC materials, hard cured SiOC materials and pyrolized SiOC materials, and combinations and variations of these, as well as alone or in combination with other building materials.

In embodiments of the LAM system, the system, and preferably the cabinet, can contain the following additional components: automatic air filters, starting material bulk storage, compressor for delivering air to clean the finished article, internal filtering system to enable the build area (e.g., the location where the functional laser beam is interacting with and fusing the starting materials) to remain clean and free of dust or other materials that would interfere with the laser beam's travel along the laser beam path. Further, the controller can be located in the cabinet, adjacent to the cabinet, or in a remote location, but in control and data communication with the system. Oxygen monitors in both the build chamber and filter can also be used, and preferably are used, to continuously monitor the absence of oxygen.

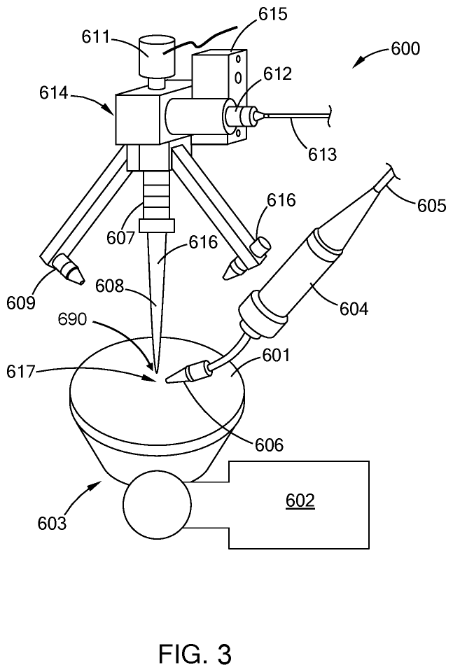

Turning to FIG. 3 there is provided a perspective view of a LAM build area 600. The build area 600 has a build table 601 that has a drive motor 602, which is connected to the table 601 by articulated robot 603. In this manner the motion of the table, turning, angle, standoff distance can be controlled. A starting material, that is an SiOC starting material, alone or with other starting materials, is delivered by a delivery assembly 604, which is connected to a starting material feed line 605 and a nozzle 606 positioned adjacent the location where the laser beam 608 is targeted. The laser beam 608 is delivered from the laser head 614. The laser head 614 has a camera 611 for viewing the LAM process, a connector 612 and optical fiber 613 for delivering the functional laser beam from the laser unit, and beam shaping optics assembly 607, e.g., focusing optics, for delivering the laser beam 608 along a laser beam path 616 to the target area 617, where the SiOC starting material 690 is located. The laser head 614 has two laser position determining devices, 609, 610 which use laser beams to measure and monitor the position size and shape of the article as it is built during the LAM process. The laser head 614 has a mount 615 that is connected to a frame not shown. The frame and the drive motor 602 may also be integral and movable to provide additional types of relative motion.

The following examples are provided to illustrate various embodiments of systems, processes, compositions, applications and materials of the present inventions. These examples are for illustrative purposes, may be prophetic, and should not be viewed as, and do not otherwise limit the scope of the present inventions.

### EXAMPLE 1

A LAM system having a starting material that includes one or more of the SiOC precursor, cured, hard cured or pyrolized materials that are disclosed and taught in U.S. Pat. No. 9,815,952, (Appendix A, hereto) the entire disclosure of which is incorporated herein by reference.

### EXAMPLE 2

A LAM system having a starting material that includes one or more of the SiOC precursor, cured, hard cured or pyrolized materials that are disclosed and taught in U.S. Pat. No. 9,815,943, (Appendix B, hereto) the entire disclosure of which is incorporated herein by reference.

### EXAMPLE 3

A LAM system having a starting material that includes one or more of the SiOC precursor, cured, hard cured or pyrolized materials that are disclosed and taught in U.S. Pat. No. 10,167,366, (Appendix C, hereto) the entire disclosure of which is incorporated herein by reference.

### EXAMPLE 4

A LAM system having a starting material that includes one or more of the SiOC precursor, cured, hard cured or pyrolized materials that are disclosed and taught in U.S. Pat. No. 9,499,677, (Appendix D, hereto) the entire disclosure of which is incorporated herein by reference.

### EXAMPLE 5

A LAM system having a starting material that includes one or more of the SiOC precursor, cured, hard cured or pyrolized materials that are disclosed and taught in US Patent No. 2017/0368668, (Appendix E, hereto) the entire disclosure of which is incorporated herein by reference.

### EXAMPLE 6

A LAM system having a starting material that includes one or more of the SiOC precursor, cured, hard cured or pyrolized materials that are disclosed and taught in US Patent No. 2019/0315969, (Appendix F, hereto) the entire disclosure of which is incorporated herein by reference.

### EXAMPLE 7

A LAM system having a starting material that includes one or more of the SiOC precursor, cured, hard cured or pyrolized materials that are disclosed and taught in US Patent No. 2018/0065995, (Appendix G, hereto) the entire disclosure of which is incorporated herein by reference.

### EXAMPLE 8

A LAM starting material that includes one or more of the SiOC precursor, cured, hard cured or pyrolized materials that are disclosed and taught in U.S. Pat. No. 9,815,952, (Appendix A, hereto) the entire disclosure of which is incorporated herein by reference.

### EXAMPLE 9

A LAM starting material that includes one or more of the SiOC precursor, cured, hard cured or pyrolized materials that are disclosed and taught in U.S. Pat. No. 9,815,943, (Appendix B, hereto) the entire disclosure of which is incorporated herein by reference.

### EXAMPLE 10

A LAM starting material that includes one or more of the SiOC precursor, cured, hard cured or pyrolized materials that are disclosed and taught in U.S. Pat. No. 10,167,366, (Appendix C, hereto) the entire disclosure of which is incorporated herein by reference.

### EXAMPLE 11

A LAM starting material that includes one or more of the SiOC precursor, cured, hard cured or pyrolized materials that are disclosed and taught in U.S. Pat. No. 9,499,677, (Appendix D, hereto) the entire disclosure of which is incorporated herein by reference.

### EXAMPLE 12

A LAM starting material that includes one or more of the SiOC precursor, cured, hard cured or pyrolized materials that are disclosed and taught in US Patent Publication No. 2017/0368668, (Appendix E, hereto) the entire disclosure of which is incorporated herein by reference.

### EXAMPLE 13

A LAM starting material that includes one or more of the SiOC precursor, cured, hard cured or pyrolized materials that are disclosed and taught in US Patent Publication No. 2019/0315969, (Appendix F, hereto) the entire disclosure of which is incorporated herein by reference.

### EXAMPLE 14

A LAM starting material that includes one or more of the SiOC precursor, cured, hard cured or pyrolized materials that are disclosed and taught in US Patent Publication No. 2018/0065995, (Appendix G, hereto) the entire disclosure of which is incorporated herein by reference.

### EXAMPLE 15

Building an article that has from 1% to 100% SiOC using an OAM system from a starting material that includes one or more of the materials disclosed and taught in in U.S. Pat. Nos. 9,815,952, 9,815,943, 10,167,366, 9,499,677, and in US Patent Publication Nos. 2017/0368668, 2019/0315969, and 2018/0065995, the entire disclosure of which is incorporated herein by reference.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. The theories put forth in this specification, and unless expressly stated otherwise, in no way limit, restrict or narrow the scope of protection to be afforded the claimed inventions. These theories many not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and with existing equipment or activities which may be modified, in-part, based on the teachings of this specification. Further, the various embodiments set forth in this specification may be used with each other in different and various combinations. Thus, for example, the configurations provided in the various embodiments of this specification may be used with each other; and the scope of protection afforded the present inventions should not be limited to a particular embodiment, configuration or arrangement that is set forth in a particular embodiment, example, or in an embodiment in a particular Figure.

The invention may be embodied in other forms than those specifically disclosed herein without departing from its spirit or essential characteristics. The described embodiments are to be considered in all respects only as illustrative and not restrictive.

What is claimed:

1. A laser additive manufacturing apparatus (LAM) comprising:
a polymer derived ceramic build material.

2. The LAM of claim 1, wherein the polymer derived ceramic build material comprises SiOC.

3. The LAM of claim 2, wherein the polymer derived ceramic build material comprises a liquid.

4. The LAM of claim 2, wherein the polymer derived ceramic build material comprises a solid.

5. The LAM of claim 2, wherein the polymer derived ceramic build material comprises a hard cured material.

6. The LAM of claim 2, wherein the polymer derived ceramic build material comprises a cured material.

7. The LAM of claim 2, wherein the polymer derived ceramic build material comprises a ceramic material.

8. A method of additive manufacturing comprising:
providing a build material selected from the group consisting of one or more of the materials, precursors, particles, pigments, cured materials, hard cured materials and pyrolized materials that are disclosed in in U.S. Pat. Nos. 9,815,952, 9,815,943, 10,167,366, 9,499,677, and in US Patent Publication Nos. 2017/0368668, 2019/0315969, and 2018/0065995, the entire disclosure of which is incorporated herein by reference.
directing light in a predetermined illumination pattern at the build material, wherein the build material is formed into an article having a predetermined shape that is based upon the predetermined illumination pattern.

9. The method of claim 8, wherein the directed light is a laser beam.

10. The method of claim 9 , wherein the directed light has a wavelength in the IR range.

11. The method of claim 8, wherein the directed light has a wavelength in the visible range.

12. The method of claim 8, wherein the directed light has a wavelength in the UV range.

13. The method of claim 8, wherein the build material comprises a metal selected from the group consisting of titanium, aluminum, copper, steel, silver, gold, and alloys thereof.

14. An additive manufacturing apparatus (AM) comprising:
a polymer derived ceramic build material.

15. The AM of claim 14, wherein the apparatus is selected from the group consisting of optical additive manufacturing (OAM), laser additive manufacturing (LAM), Fused deposition modeling (FDM), Stereolithography (SLA), Digital Light Processing (DLP), Selective Laser Sintering (SLS), Selective laser melting (SLM), Laminated object manufacturing (LOM) and Digital Beam Melting (EBM).

16. The AM of claim 14, wherein the polymer derived ceramic build material comprises a liquid.

17. The AM of claim 14, wherein the polymer derived ceramic build material comprises a solid.

18. The AM of claim 14, wherein the polymer derived ceramic build material comprises a hard cured material.

19. The AM of claim 14, wherein the polymer derived ceramic build material comprises a cured material.

20. The AM of claim 14, wherein the polymer derived ceramic build material comprises a ceramic material.
